(19) United States
(12) Patent Application Publication
(10) Pub. No.: US 2021/0277848 A1
(43) Pub. Date: Sep. 9, 2021

(54) WATER DELIVERY SYSTEM FOR DELIVERING DEMINERALIZED WATER TO A COMBUSTION ENGINE, AND DEMINERALIZATION APPARATUS

(71) Applicant: Röchling Automotive SE & Co. KG, Mannheim (DE)

(72) Inventors: Fabrizio Chini, Isera (IT); Gloria Paoli, Riva Del Garda (IT); Francesca Sartori, Trento (IT); Edoardo Martelli, Appiano (IT); Filippo Dall'armellina, Bolzano (IT); Luca Antoniazzi, Bolzano (IT)

(21) Appl. No.: 17/101,448

(22) Filed: Nov. 23, 2020

(30) Foreign Application Priority Data
Nov. 29, 2019 (DE) 10 2019 132 562.5

(51) Int. Cl. F02M 25/03; C02F 1/44; C02F 1/42; C02F 5/02; C02F 1/00; F02M 25/022

(52) U.S. Cl. CPC F02M 25/03; C02F 1/441; C02F 1/42; C02F 2103/023; C02F 1/008; F02M 25/0222; C02F 5/02

(57) ABSTRACT

A water delivery system for delivering demineralized water to a consuming unit of a motor vehicle, in particular to a combustion engine, encompassing: a water tank having a filling opening; a first aspiration line; a first water pump; a discharge line; a discharge apparatus; a demineralization apparatus for demineralizing water; the first water pump being fluidically connected via the first aspiration line to an internal volume of the water tank; the discharge apparatus being fluidically connected via the discharge line to the first water pump.

This Application claims priority in German Patent Application DE 10 2019 132 562.5 filed on Nov. 29, 2019, which is incorporated by reference herein.

The present invention relates to a water delivery system for delivering demineralized water to a consuming unit in a motor vehicle, in particular to a combustion engine; and to a demineralization apparatus.

### BACKGROUND OF THE INVENTION

In vehicles having a combustion engine, in particular having a gasoline engine, water delivery systems are used in order to reduce the peak temperature in a combustion chamber of the combustion engine. Improvements in the performance and emissions of the combustion engine can thereby be achieved. Water delivery systems deliver water to the combustion engine by the fact that water is introduced, in particular atomized, directly into a combustion chamber, or by the fact that water is introduced in the vicinity of a combustion chamber, e.g. introduced, in particular atomized, into the intake duct.

In order to prevent accelerated wear, corrosion, and deposits in the combustion engine and in the water delivery system, the water used is demineralized water. If utility water, e.g. drinking water, which contains dissolved ions, particulates, and other contaminants, were used, this might result in irreparable damage to the combustion engine. The damage can be caused in particular by the fact that upon the introduction of water at high ambient temperatures into the combustion engine, the water can experience a phase transition during which salts dissolved in the water can again assume their solid form, become deposited onto surfaces of the combustion engine, and thus increase wear in the combustion engine. Ions dissolved in the water can also permanently damage catalytic converters in an exhaust system of the combustion engine.

Demineralization apparatuses are arranged in water delivery systems in order to allow water delivery systems nevertheless to be filled with utility water. A water delivery system of this kind is known from the document WO 2017/137100 A1. The embodiments shown therein, however, either are complex and difficult to maintain, or a backflow of water into a water tank can be only insufficiently controlled.

### SUMMARY OF THE INVENTION

An object of the present invention is therefore to furnish a simplified water delivery system that in particular is easily maintainable, or in particular furnishes easily controllable flow paths.

The invention furnishes, in particular, a water delivery system for delivering demineralized water to a consuming unit in a motor vehicle. Such a consuming unit is preferably a combustion engine. Such a consuming unit can, however, also be a fuel cell or a battery cooling circuit. The water delivery system encompasses: a water tank having a filling opening; a first aspiration line; a first water pump; a discharge line; a discharge apparatus; and a demineralization apparatus for demineralizing water. The first water pump is fluidically connected via the first aspiration line to an internal volume of the water tank, and the discharge apparatus is fluidically connected via the discharge line to the first water pump,

a) the water delivery system encompassing a demineralization circuit that comprises a second aspiration line, a second water pump, a pump line, and a return line, the second water pump being fluidically connected via the second aspiration line to an internal volume of the water tank; an inlet of the demineralization apparatus being fluidically connected via the pump line to the second water pump; and an outlet of the demineralization apparatus being fluidically connected via the return line to the internal volume of the water tank; or

b) the water delivery system encompassing a demineralization arm that comprises a three-way valve, a pump line, and a return line, a first discharge line sub-portion of the discharge line fluidically connecting the three-way valve to the first water pump; a second discharge line sub-portion of the discharge line fluidically connecting the three-way valve to the discharge apparatus; the pump line fluidically connecting an inlet of the demineralization apparatus to the three-way valve; and an outlet of the demineralization apparatus being fluidically connected via the return line to the internal volume of the water tank; or

c) the water delivery system encompassing a filler neck that fluidically connects the filling opening to the internal volume of the water tank; and the demineralization apparatus being arranged in the filler neck; or

d) the water delivery system encompassing, downstream from the first water pump, a demineralization bypass that comprises a first branch line and a second branch line, an inlet of the demineralization apparatus being fluidically connected by the first branch line to a first branching point of the discharge line downstream from the first water pump; and an outlet of the demineralization apparatus being fluidically connected by the second branch line to a second branching point of the discharge line downstream from the first branching point; or

e) the demineralization apparatus dividing the internal volume of the water tank into two separate sub-volumes; or

f) the water delivery system encompassing, upstream from the first water pump, a demineralization arm that comprises a three-way valve, a pump line, a direct aspiration line, an intermediate line, and a demineralization aspiration line, the pump line fluidically connecting the three-way valve to the first water pump; the direct aspiration line fluidically connecting the three-way valve directly to the internal volume of the water tank; the intermediate line fluidically connecting the three-way valve to an outlet of the demineralization apparatus; and the demineralization aspiration line fluidically connecting an inlet of the demineralization apparatus directly to the internal volume of the water tank; the first aspiration line being embodied as the direct aspiration line.

The consuming unit supplied with demineralized water will be assumed hereinafter, merely by way of example, to be a combustion engine. Instead of the combustion engine, however, any other type of consuming unit can be supplied with demineralized water.

The term “three-way valve” refers in the present Application to a valve having at least three openings. It is not to be excluded that a “three-way valve” for purposes of the present Application comprises more than three openings, i.e. for example is a four-, five- or otherwise multi-opening valve. The three-way valve referred to is preferably a valve having exactly three openings.

In the water delivery system according to a), utility water can be introduced into the filling opening; it can be pumped by means of the second water pump through the demineralization circuit and can be returned back to the internal volume of the water tank. As a result, either the demineralization apparatus can have small dimensions because water can be pumped out of the water tank repeatedly through the demineralization circuit until a desired degree of demineralization of the water in the water tank is achieved, or only some of the water in the water tank can be pumped through the demineralization circuit until a desired, in particular predetermined, degree of demineralization of the water in the water tank is achieved. Water that exhibits the desired, in particular predetermined, degree of demineralization is “demineralized water” in the context of this Application. The demineralization apparatus can be part of the demineralization circuit. The demineralization circuit controls the return flow of water into the water tank, and thus a flow path.

A “degree of demineralization” corresponds, for instance, to a concentration of ions in the water. The degree of demineralization can be regarded as equivalent to the inverse of the conductivity of the water, and can be determined by measuring the conductivity of the water.

In the water delivery system according to b), utility water can be introduced into the filling opening; when the three-way valve blocks the fluidic connection between the first water pump and the discharge apparatus, and opens the fluidic connection between the first water pump and the demineralization apparatus, the water can be pumped through the demineralization arm and can be returned back to the internal volume of the water tank. As a result, either the demineralization apparatus can have small dimensions because water can be pumped out of the water tank repeatedly through the demineralization arm until a desired degree of demineralization of the water in the water tank is achieved, or only some of the water in the water tank can be pumped through the demineralization arm until a desired degree of demineralization of the water in the water tank is achieved. A further water pump can also be omitted. The demineralization apparatus can be part of the demineralization arm. Flow paths are controlled by means of the three-way valve.

The first discharge line sub-portion of the discharge line is, in particular, embodied separately from the second discharge line sub-portion of the discharge line.

In the water delivery system according to c), utility water can be introduced into the filling opening; it is demineralized by the demineralization apparatus, so that only demineralized water is stored in the water tank, and apparatuses for demineralizing the water present in the water tank can be omitted and the water delivery system is thus of particularly simple configuration.

In the water delivery system according to d), utility water can be pumped out of the internal volume of the water tank by the first water pump both through the discharge line and through the demineralization bypass fluidically connected in parallel with the discharge line, so that that part of the water which flows through the demineralization bypass becomes demineralized by the demineralization apparatus and is not mixed again with the water flowing through the demineralization bypass. With suitably selected flow resistance values of the demineralization bypass, of the demineralization apparatus, and of the discharge line between the first and the second branching point, and with a correspondingly selected performance level for the demineralization apparatus assuming a minimal degree of demineralization of the utility water that is used, the water downstream from the second branching point exhibits a desired minimum value of degree of demineralization with no need for additional regulation of the demineralization apparatus.

The water delivery system according to e) is of particularly simple configuration, since a pump is not needed in order to pump utility water through the demineralization apparatus.

In particular, the demineralization apparatus is arranged in the filler neck upstream from the internal volume of the water tank and downstream from the filling opening, in a portion of the filler neck that fluid-conveyingly connects the filling opening to the internal volume of the water tank.

The demineralization apparatus is arranged preferably accessibly, in particular replaceably, particularly preferably replaceably through the filling opening.

In particular, the demineralization circuit is fluidically connected to the discharge line only via the water tank. Preferably, the first water pump is different from the second water pump and arranged separately.

The water tank can be embodied by injection molding or by blow-molding.

The water delivery system according to f) allows a higher-order system or a user to select, in the context of aspiration of water from the water tank, whether or not the water is to be conveyed through the demineralization apparatus, with the result that demineralizing active substances in the demineralization apparatus are not unnecessarily consumed. The direct aspiration line can be embodied as part of the three-way valve; in particular, it can be embodied in one piece with a valve body of the three-way valve. The demineralization aspiration line can be embodied as part of the demineralization apparatus; in particular, it can be embodied in one piece with a housing of the demineralization apparatus. In both cases, additional components are dispensed with and the complexity of the water delivery system is reduced. Flow paths are controlled by means of the three-way valves.

The water delivery system can furthermore encompass a discharge arm that comprises a further three-way valve, a first discharge line sub-portion of the discharge line, a second discharge line sub-portion of the discharge line, and a return line; the first discharge line sub-portion of the discharge line fluidically connecting the further three-way valve to the first water pump; the second discharge line sub-portion of the discharge line fluidically connecting the further three-way valve to the discharge apparatus; and the return line fluidically connecting the further three-way valve directly to the internal volume of the water tank. The first discharge line sub-portion of the discharge line is, in particular, embodied separately from the second discharge line sub-portion of the discharge line. The return line can be embodied as part of the further three-way valve; in particular, it can be embodied in one piece with a valve body of the further three-way valve in order to reduce the complexity of the water delivery system.

The combustion engine can be a piston engine or a gas turbine. The piston engine can be a rotary piston engine or a reciprocating piston engine. The water delivery system is preferably configured to deliver the demineralized water to an intake duct and/or to a combustion chamber of the combustion engine.

The demineralization apparatus can be embodied with a replaceable cartridge. This is particularly advantageous if the water delivery system preferably encompasses a filler neck that fluidically connects the filling opening to the internal volume of the water tank, the demineralization apparatus being arranged in the filler neck. The cartridge can be configured in that context to be replaced through the filler neck. The demineralization apparatus can be maintained particularly easily in such cases; in the context of preferred replacement through the filling opening, access for introducing utility water through the filling opening simultaneously furnishes access for maintaining the demineralization apparatus, so that the water delivery system can be arranged even in confined spatial situations, since only one access is needed. A demineralizing active substance can be present in the cartridge.

In general, the demineralization apparatus can encompass a replaceable cartridge that encompasses a demineralizing active substance. Possible demineralizing active substances are described below. The demineralization apparatus can encompass a housing, having an inlet and an outlet of the demineralization apparatus arranged thereon, the housing being configured to receive the cartridge. A demineralization apparatus of this kind can be referred to as a “cartridge system.” The housing of a cartridge system can pass through a wall of the water tank. With the cartridge system in an operating state, a siphon-shaped water flow can be embodied in the cartridge system.

It is preferred that the demineralization apparatus divide the internal volume of the water tank into two separate sub-volumes; and that the demineralization apparatus be embodied with a reverse osmosis membrane. The water delivery system preferably encompasses a fluid pressure line that is connected to a fluid pressure source, for instance an air pressure source, and is fluidically connected to an internal volume of that sub-volume of the water tank which is referred to as a “utility-water sub-volume,” which is configured to receive utility water through the filling opening. The water delivery system is thereby configured to impinge upon the utility water present in the utility-water sub-volume with a pressure in order to push water molecules, against osmotic pressure, through the reverse osmosis membrane into the other sub-volume referred to as a “clean-water sub-volume.” Alternatively, a gravitational force of the utility water can furnish the pressure needed to push water molecules through the reverse osmosis membrane into the clean-water sub-volume.

The water delivery system preferably comprises a water outlet line, connected to the utility-water sub-volume, for draining the utility-water sub-volume if necessary. The filling opening can also not be directly connected to the clean-water sub-volume. The aspiration line is preferably fluidically connected to an internal volume of the clean-water sub-volume.

The reverse osmosis membrane can be constructed from polymers and/or composite materials. The composite materials can have an anisotropic cross-sectional structure, with a thin selective layer (preferably having a thickness from approx. 50 nm to 2 mm) that is arranged in particular on a microporous carrier (preferably having a thickness from 100 μm to 300 μm) in order to furnish sufficient mechanical stability with high membrane permeability.

In a particularly preferred embodiment, the water delivery system encompasses a water quality sensor fluidically connected to the internal volume of the water tank, preferably a water quality sensor arranged in the water tank, the water quality sensor preferably being embodied as a water conductivity sensor. As a result, the water delivery system is embodied to output data regarding the degree of demineralization of the water stored in the internal volume of the water tank. Preferably, the water quality sensor is arranged in the clean-water sub-volume in order to determine the degree of demineralization of the water that is discharged to the discharge apparatus via the discharge line. If a value of the degree of demineralization falls below a minimum value, the water delivery system can then output a fault message. Alternatively and/or additionally, the/a water quality sensor can be arranged in the utility-water sub-volume in order to determine the degree of demineralization of the water in the utility-water sub-volume, for instance so that the performance of the reverse osmosis membrane can be determined.

In a further preferred embodiment, the demineralization apparatus can encompass an ion exchanger as a demineralizing active substance. Demineralization of the utility water can thereby be reliably carried out. An ion exchanger can be, in particular, a porous, water-insoluble resin. Ion exchangers can encompass organic polymer chains that can comprise charged functional groups that are incorporated into a polymer framework. A functional group can have a predetermined positive or predetermined negative charge. In particular, a functional group, for instance H⁺, can be exchanged with cations such as Ca⁺⁺, Mg⁺⁺, and/or Na⁺ from the water. It is possible in particular for functional groups such as (OH)⁻ to be capable of being exchanged with all anions present in the water. Ion exchangers can encompass, in particular, a mixture of resins, at least one of which is configured to exchange a functional group for a cation from the water, and at least one further one of which is configured to exchange a functional group for an anion from the water. Alternatively, the resin or resins that is or are used can be configured to exchange either only anions, only cations, or only a specific type of ion. The IEX resin of Miontec, for example, can be used as an ion exchanger.

The demineralization apparatus can also encompass at least one demineralizing active substance which generates a precipitate in the context of a water demineralization process, and which is embodied in particular in a form of a demineralizing tablet and/or a demineralizing powder. As a result, the demineralization apparatus can be maintained in particularly simple fashion by the fact that in the context of maintenance, once the demineralizing active substance has been consumed, in particular has been converted entirely into precipitate, the precipitate is removed from, e.g. washed out of, the demineralization apparatus, and the demineralization apparatus is filled with new, unutilized demineralizing active substance. The filling operation is particularly simple thanks to the tablet form or powder form.

Demineralizing active substance, such as an ion exchanger and the above-described demineralizing tablets and demineralizing powders, can be used in cartridges or also in general in demineralization apparatuses.

The demineralization apparatus can be arranged inside the water tank, penetratingly through a water-tank wall, or outside the water tank.

The demineralization apparatus can encompass a polarized electrical electrode that is arranged inside the water tank or inside a maintainable cartridge. It is thereby particularly simple to electrically capture ions from the water. The electrode can react with the ions and, in the context of that reaction, form a precipitate in the form of a solid.

According to a further aspect of the invention, a demineralization apparatus is furnished, encompassing an inlet, an outlet, a fluid flow channel extending between the inlet and the outlet, a baffle plate arranged transversely to a principal direction of extent of the fluid flow channel; the baffle plate being shaped in such a way that the baffle plate constitutes an edge portion of a passthrough opening in the fluid flow channel, the opening cross section of which opening is smaller than an opening cross section of the fluid flow channel upstream from the baffle plate. As a result, a demineralizing active substance can be arranged at a predetermined location within the fluid flow channel through which water is to flow.

In a preferred embodiment, the demineralization apparatus further encompasses a further baffle plate arranged, directly downstream from the baffle plate, transversely to the principal direction of extent of the fluid flow channel, the further baffle plate being shaped in such a way that the further baffle plate constitutes an edge portion of a further passthrough opening in the fluid flow channel, the opening cross section of which opening is smaller than an opening cross section of the fluid flow channel upstream from the further baffle plate; and a projection of the further passthrough opening along the principal direction of extent of the fluid flow channel not completely overlapping with the passthrough opening, preferably not overlapping with the passthrough opening. An “opening cross section” is, in particular, an area of the corresponding cross section of an opening.

A flow path length of water through the demineralizing active substance, within the fluid flow channel through which water is to flow, can thereby be extended without increasing the extent of the fluid flow channel.

“Directly downstream” from the baffle plate means in this context, in particular, that no additional baffle plate arranged transversely to the principal direction of extent of the fluid flow channel is arranged along the fluid flow channel between the baffle plate and the further baffle plate.

It is likewise possible for the principal direction of extent of the fluid flow channel to follow, at least in portions, a flat spiral and/or, at least in portions, to follow a straight line and/or, at least in portions, to follow the course of a helix or coil. Thanks to the selection of such principal directions of extent, the demineralization apparatus can be embodied to be particularly compact.

It is preferred to combine both aspects of the invention, so that the above-described water delivery system encompasses the demineralization apparatus in accordance with the above-described further aspect of the invention. The demineralization apparatus can also have a cylindrical shape, in particular can be configured in accordance with the embodiments of the document DE 10 2014 220 120 A1, which is herewith incorporated by reference into the Application.

Also appurtenant to the invention, in addition to the water delivery system according to the present invention, is a combustion engine having the water delivery system according to the present invention, the combustion engine being in particular an internal combustion engine, particularly preferably a gasoline engine or diesel engine, the water delivery system delivering demineralized water to the combustion engine or to its accessories.

Also appurtenant to the invention is a vehicle having a combustion engine according to the present invention; the vehicle can be a motor vehicle, in particular a commercial vehicle or passenger vehicle.

When a first element is described in this Application as being located, arranged, or the like “upstream” from a second element, this means, as is usual in particular in ordinary usage, that the second element follows the first element with reference to a water flow direction. When a first element is described in this Application as being located, arranged, or the like “downstream” from a second element, this means, as is usual in particular in ordinary usage, that the first element follows the second element with reference to a water flow direction.

The discharge apparatus is preferably an atomization nozzle that is embodied to be arranged in an intake duct and/or combustion chamber of a combustion engine, and to atomize demineralized water in the intake duct and/or combustion chamber.

The first water pump is, in particular, arranged upstream from the discharge apparatus.

For the sake of completeness, however, be it noted that, if a three-way valve is to be brought into a defined state but it is already in that state, no action is performed but a step of bringing the three-way valve into that state is nevertheless to be regarded as having been performed.

A three-way valve comprises in particular three ports, and can assume states in which a fluidic connection is constituted respectively between two of those ports (those ports being respectively referred to as “open”) and, in the context of utilization as intended, any fluidic connection from those two ports to the third port is precluded (the third port being referred to as “closed”). In addition, the three-way valve can preferably assume a state in which, in the context of utilization as intended, any fluidic connection between the ports is precluded. It is preferred that the three-way valve not be able to assume a state in which a fluidic connection among all three ports is constituted.

A “fluidic connection” is to be understood as a connection through which a fluid can pass in a context of utilization as intended. This is analogously true for “fluidically connecting.”

The methods according to the invention of this application allows elimination of an excessively low degree of demineralization of water stored in the water tank. Advantageously, one operating mode, A) or B), can be selected depending on the operating state of the consuming unit. Operating mode A) enables recirculation of water in the water tank, and demineralization thereof in that context. Operating mode B) enables demineralization of water while it is being discharged to the consuming unit.

These and other objects, aspects, features and advantages of the invention will become apparent to those skilled in the art upon a reading of the Detailed Description of the invention set forth below taken together with the drawings which will be described in the next section.

### BRIEF DESCRIPTION OF THE DRAWINGS

The invention may take physical form in certain parts and arrangement of parts, a preferred embodiment of which will be described in detail and illustrated in the accompanying drawings which forms a part hereof and wherein:

FIG. 1 shows a first embodiment according to the present invention of the water delivery system;

FIG. 2 shows a second embodiment according to the present invention of the water delivery system;

FIG. 3 shows a third embodiment according to the present invention of the water delivery system;

FIG. 4 shows a fourth embodiment according to the present invention of the water delivery system;

FIG. 5 shows a fifth embodiment according to the present invention of the water delivery system;

FIG. 6 shows a sixth embodiment according to the present invention of the water delivery system;

FIG. 7 shows a seventh embodiment according to the present invention of the water delivery system;

FIG. 8 shows an eighth embodiment according to the present invention of the water delivery system;

FIG. 9 shows a first embodiment according to the present invention of the demineralization apparatus, without a housing cover;

FIGS. 10 to 13 show baffle plates of the demineralization apparatus of FIG. 9;

FIG. 14 is a view of the demineralization apparatus of FIG. 9 with a housing cover;

FIG. 15 shows a second embodiment according to the present invention of the demineralization apparatus, without a housing cover;

FIG. 16 shows a portion of a cross section A-A from FIG. 15;

FIG. 17 shows a portion of a cross section B-B from FIG. 15; and

FIG. 18 is a view of the demineralization apparatus of FIG. 15 with a housing cover.

### DESCRIPTION OF PREFERRED EMBODIMENTS

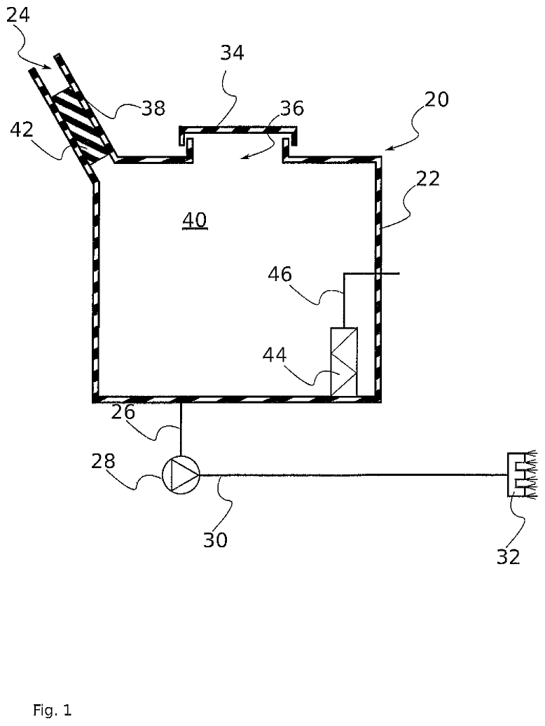

Referring now to the drawings wherein the showings are for the purpose of illustrating preferred and alternative embodiments of the invention only and not for the purpose of limiting the same, FIG. 1 shows a first embodiment of water delivery system 20 for delivering demineralized water to a combustion engine, encompassing: a water tank 22 having a filling opening 24; a first aspiration line 26; a first water pump 28; a discharge line 30; a discharge apparatus 32 embodied as an atomization nozzle; a water tank cover 34 for closing off a maintenance opening 36; and a filler neck 38 that fluidically connects an internal volume 40 of water tank 22 to filling opening 24. First aspiration line 26 fluidically connects interior 40 of water tank 22 to first water pump 28. Discharge line 30 fluidically connects discharge apparatus 32 to first water pump 28, which conveys water (not shown), which is present in water tank 22, through first aspiration line 26 and discharge line 30 to discharge apparatus 32.

Throughout the Application, the fluidic connections via lines, pumps, valves and so forth are not described in detail; the demineralization apparatuses are also depicted only schematically. A depiction of water is also omitted.

Arranged within filler neck 38 is a demineralization apparatus 42 that constitutes a cartridge filled with an ion exchanger and can be removed and reinserted through filling opening 24. When utility water, for instance tap water, is introduced through filling opening 24, all of the introduced utility water flows through demineralization apparatus 42 and becomes demineralized therein and thereby converted into demineralized water, which can also be referred to in the Application as “clean water,” which is then collected in internal volume 40 of water tank 22. The degree of demineralization is measured by a water quality sensor 44 that is arranged in internal volume 40 of water tank 22 and is embodied as a water conductivity sensor, water quality sensor 44 furnishing, via a signal line 46, a signal that carries information regarding the degree of demineralization.

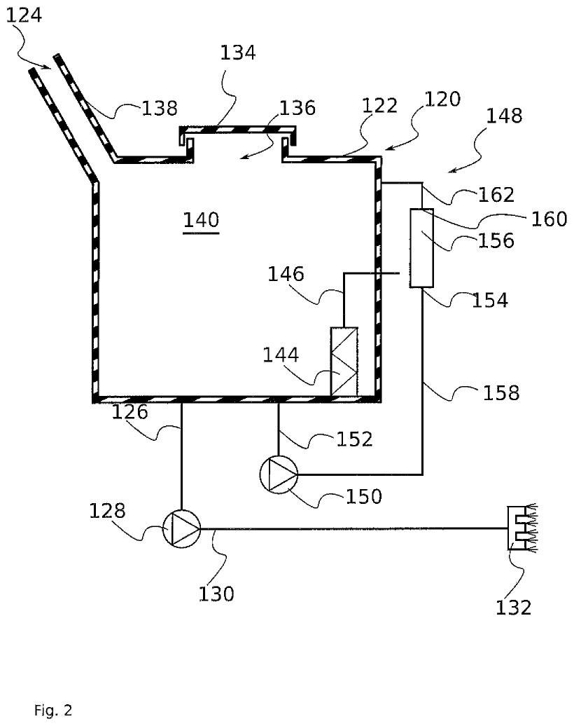

FIG. 2 shows a second embodiment of water delivery system 120 for delivering demineralized water to a combustion engine, only the differences from the first embodiment being discussed in the description. In the second embodiment, elements and components that correspond to those of the first embodiment have associated with them reference characters that are incremented by 100 with respect to the reference characters of the corresponding components and elements of the first embodiment. For those components, reference is made explicitly to the statements regarding the first embodiment, which are also to be applied to the second embodiment.

Water delivery system 120 encompasses a demineralization circuit 148 encompassing a second water pump 150 that is fluidically connected via a second aspiration line 152 to an internal volume 140 of water tank 122. In demineralization circuit 148, an inlet 154 of a demineralization apparatus 156 is fluidically connected via a pump line 158 to second water pump 150. Also in demineralization circuit 148, an outlet 160 of demineralization apparatus 156 is fluidically connected via a return line 162 to internal volume 140 of water tank 122. Second water pump 150 conveys the water or utility water out of water tank 122 through demineralization apparatus 156, that water component being demineralized, and that demineralized water being returned back into internal volume 140 of water tank 122. This process begins as soon as water quality sensor 144 measures too low a degree of demineralization in internal volume 140 of water tank 122. This process ends as soon as water quality sensor 144 ascertains a sufficiently high predetermined degree of demineralization in internal volume 140 of water tank 122, since a sufficiently large proportion of the water in internal volume 140 of water 122 has been pumped sufficiently often through demineralization apparatus 156 and has thus been demineralized to a certain degree with each pass. Demineralization apparatus 156 can be embodied as a cartridge system.

Second water pump 150, second aspiration line 152, pump line 158, demineralization apparatus 156, and return line 162 can be part of, or can constitute, demineralization circuit 148.

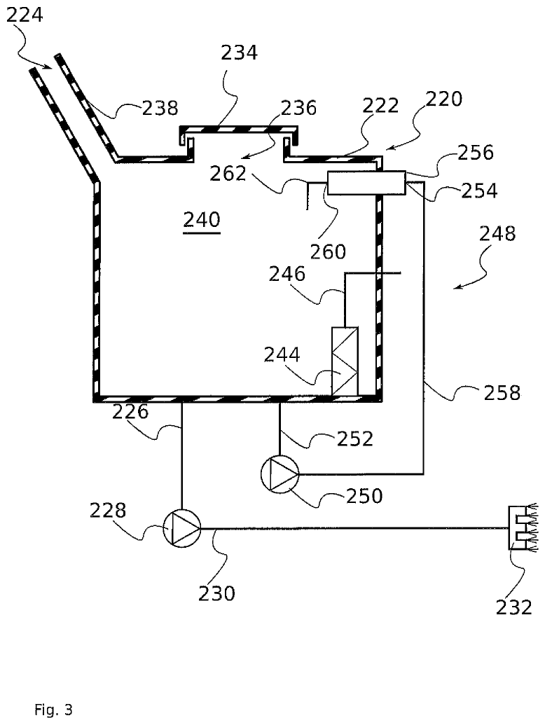

FIG. 3 shows a third embodiment of water delivery system 220 for delivering demineralized water to a combustion engine, only the differences from the second embodiment being discussed in the description. In the third embodiment, elements and components that correspond to those of the second embodiment have associated with them reference characters that are incremented by 100 with respect to the reference characters of the corresponding components and elements of the second embodiment. For those components, reference is made explicitly to the statements regarding the second embodiment, which are also to be applied to the third embodiment.

Water delivery system 220 of the third embodiment differs from that of the second embodiment in that demineralization apparatus 256 is not arranged, like demineralization apparatus 156, outside water tank 122, but instead penetrates through a wall of water tank 222; and in that return line 262 extends in internal volume 240 of water tank 222. Return line 262 can, in this case, be omitted.

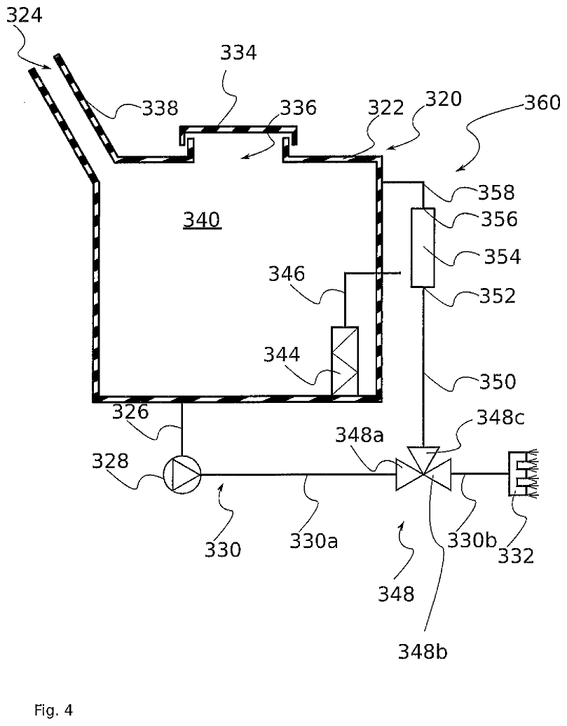

FIG. 4 shows a fourth embodiment of water delivery system 320 for delivering demineralized water to a combustion engine, only the differences from the first embodiment being discussed in the description. In the fourth embodiment, elements and components that correspond to those of the first embodiment have associated with them reference characters that are incremented by 300 with respect to the reference characters of the corresponding components and elements of the first embodiment. For those components, reference is made explicitly to the statements regarding the first embodiment, which are also to be applied to the fourth embodiment.

Discharge line 330 comprises two discharge line sub-portions 330a and 33b, between which a three-way valve 348 is inserted; discharge line sub-portion 330a fluidically connects first water pump 328 to a first port 348a of three-way valve 348, and discharge line sub-portion 330b fluidically connects a second port 348b of three-way valve 348 to discharge apparatus 332. A third port 348c of three-way valve 348 is fluidically connected via a pump line 350 to an inlet 352 of a demineralization apparatus 354. An outlet 356 of demineralization apparatus 354 is fluidically connected via a return line 358 to internal volume 340 of water tank 322.

Three-way valve 348, pump line 350, demineralization apparatus 354, and return line 358 are part of, or constitute, a demineralization arm 360 of water delivery system 320.

Three-way valve 348 encompasses three ports 348a, 348b, and 348c, which can each be opened or closed in operating states of three-way valve 348. Three-way valve 348 preferably has a discharge state in which ports 348a and 348b are opened and port 348c is closed, and a flow of water from first water pump 328 to the consuming unit is thus enabled while a flow of water from first water pump 328 through demineralization apparatus 354 is precluded.

Three-way valve 348 preferably furthermore has a demineralization state in which ports 348a and 348c are opened and port 348b is closed, and a flow of water from first water pump 328 to the consuming unit is thus precluded while a flow of water from first water pump 328 through pump line 352, demineralization apparatus 354, and return line 358 back into interior 340 of water tank 322 is enabled.

If water quality sensor 344 measures too low a degree of demineralization of the water in internal volume 340 of water tank 322, three-way valve 348 is then brought into the demineralization state and first water pump 328 conveys the water, or utility water, from water tank 322 through demineralization apparatus 354, that water component being demineralized and that demineralized water being returned back into interior 340 of water tank 322. This process ends as soon as water quality sensor 344 ascertains a sufficiently high predetermined degree of demineralization in internal volume 340 of water tank 322, and thus ascertains the presence of demineralized water in water tank 322, since a sufficiently large proportion of the water in internal volume 340 of water tank 322 has been pumped sufficiently often through demineralization apparatus 354 and has thus been demineralized to a certain degree with each pass. Once the process ends, three-way valve 348 is brought into the discharge stage and first water pump 328 conveys demineralized water out of internal volume 340 of water tank 322 to discharge apparatus 332. In this exemplifying embodiment as well, demineralization apparatus 354 can be embodied as a cartridge system.

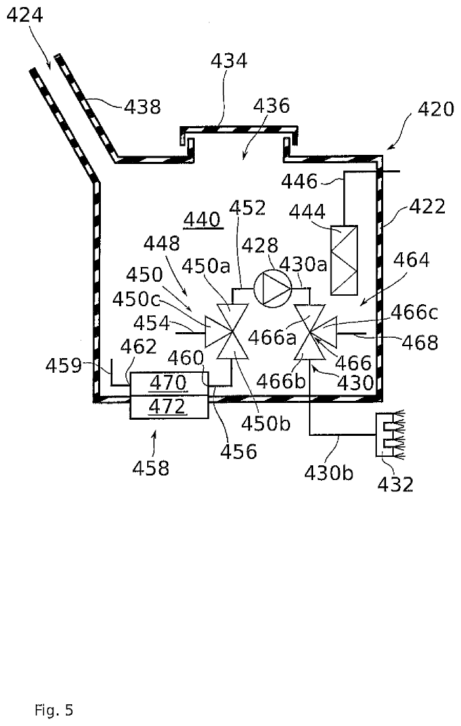

FIG. 5 shows a fifth embodiment of water delivery system 420 for delivering demineralized water to a combustion engine, only the differences from the first embodiment being discussed in the description. In the fifth embodiment, elements and components that correspond to those of the first embodiment have associated with them reference characters that are incremented by 400 with respect to the reference characters of the corresponding components and elements of the first embodiment. For those components, reference is made explicitly to the statements regarding the first embodiment, which are also to be applied to the fifth embodiment.

Note that in FIG. 5 in particular, the arrangement of water quality sensor 444 and of ends of lines is schematic, and that one skilled in the art would arrange the water quality sensor and, in particular, ends of lines that remove liquid from internal volume 440 of water tank 422, close to a bottom of water tank 422 or in a sump of water tank 422 in order to ensure functionality of the water delivery system.

Water delivery system 420 encompasses, upstream from first water pump 428, a demineralization arm 448 that comprises a three-way valve 450, a pump line 452, a direct aspiration line 454, an intermediate line 456, and a demineralization aspiration line 459. Three-way valve 450 encompasses three ports 450a, 450b, and 450c that can each be opened or closed in operating states of three-way valve 450. Pump line 452 fluidically connects first water pump 428 to port 450a of three-way valve 450. Direct aspiration line 454 fluidically connects interior 440 of water tank 442 to port 450c of three-way valve 450. Intermediate line 456 fluidically connects an outlet 460 of demineralization apparatus 458 to port 450b of three-way valve 450, and demineralization aspiration line 459 fluidically connects an inlet 462 of demineralization apparatus 458 to internal volume 440 of water tank 442.

Three-way valve 450 preferably has a demineralization aspiration state in which ports 450a and 450b are opened and port 450c is closed, and first water pump 428 is therefore configured to aspirate water out of internal volume 440 of water tank 442 through demineralization apparatus 458.

Also preferably, three-way valve 450 furthermore has a direct aspiration state in which ports 450a and 450c are opened and port 450b is closed, and first water pump 458 is therefore configured to aspirate water out of internal volume 440 of water tank 442 without causing it to pass through demineralization apparatus 458.

Water delivery system 420 further encompasses a discharge arm 464 downstream from first water pump 428, which arm comprises a further three-way valve 466, a first discharge line sub-portion 430a of discharge line 430, a second discharge line sub-portion 430b of discharge line 430, and a return line 468.

Further three-way valve 466 encompasses three ports 466a, 466b, and 466c that can each, in operating states of three-way valve 466, be opened or closed. First discharge line sub-portion 430a of discharge line 430 fluidically connects first water pump 428 to port 466a of further three-way valves 466. Second discharge line sub-portion 430b of discharge line 430 fluidically connects port 466b of further three-way valve 466 to discharge apparatus 432. Return line 468 fluidically connects port 466c of further three-way valve 466 to internal volume 440 of water tank 442.

Three-way valve 466 preferably has a discharge state in which ports 466a and 466b are opened and port 466c is closed, and first water pump 428 is therefore configured to deliver water to discharge apparatus 432.

Also preferably, three-way valve 466 furthermore has a circulation state in which ports 466a and 466c are opened and port 466b is closed, and first water pump 428 is therefore configured to convey water into interior 440 of water tank 442.

If water quality sensor 444 measures too low a degree of demineralization of the water in internal volume 440 of water tank 422, two operating modes can then be assumed:

A) Three-way valve 450 is brought into the demineralization aspiration state and further three-way valve 466 is brought into the circulation state, and first water pump 428 conveys water or utility water out of water tank 422 through demineralization apparatus 458, that water component being demineralized and that demineralized water being returned back into interior 440 of water tank 422. This process ends as soon as water quality sensor 444 ascertains a sufficiently high predetermined degree of demineralization in internal volume 440 of water tank 422 (and thus ascertains that demineralized water is present in internal volume 440 of water tank 422), since a sufficiently large proportion of the water in internal volume 440 of water tank 422 has been pumped sufficiently often through demineralization apparatus 458 and has thus been demineralized to a certain degree with each pass. In this process, no water is delivered to the discharge apparatus; this process is therefore correspondingly preferred when the combustion engine is shut off.

B) Three-way valve 450 is brought into the demineralization aspiration state and further three-way valve 466 is brought into the discharge state, and first water pump 428 conveys water or utility water out of water tank 422 through demineralization apparatus 458, in which it becomes demineralized and is thus converted into demineralized water, to discharge apparatus 432. This process is preferred during operation of the combustion engine.

If water quality sensor 444 measures a predetermined or higher degree of demineralization of the water in internal volume 440 of water tank 422, the following operating mode can be assumed:

C) Three-way valve 450 is brought into the direct aspiration state and further three-way valve 466 is brought into the discharge state, and first water pump 428 conveys demineralized water out of the water tank to discharge apparatus 432 without causing it to pass through demineralization apparatus 458.

At least one housing portion 470 of demineralization apparatus 458 is preferably embodied as part of a wall, in particular a floor, of water tank 422, and demineralization apparatus 458 can be a cartridge system. A cartridge 472 containing a demineralizing active substance can be inserted from outside (with reference to internal space 440 of water tank 422) into housing portion 470. Alternatively, instead of cartridge 472 a cover can be provided which, for example, is screwed onto housing portion 470 and retains a demineralizing active substance in an internal space of housing portion 470.

A first water pump, such as water pump 428, can be arranged in the internal volume of the water tank. A three-way valve, such as three-way valves 466 and 450, can be arranged in the internal volume of the water tanks.

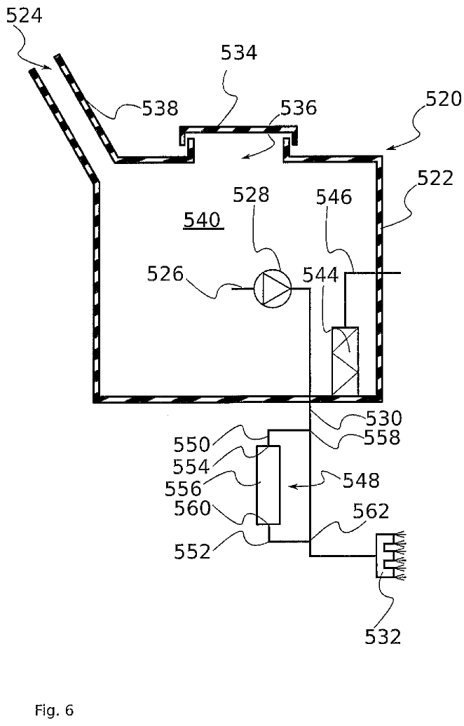

FIG. 6 shows a sixth embodiment of water delivery system 520 for delivering demineralized water to a combustion engine, only the differences from the first embodiment being discussed in the description. In the sixth embodiment, elements and components that correspond to those of the first embodiment have associated with them reference characters that are incremented by 500 with respect to the reference characters of the corresponding components and elements of the first embodiment. For those components, reference is made explicitly to the statements regarding the first embodiment, which are also to be applied to the sixth embodiment.

Water delivery system 520 encompasses, downstream from first water pump 528, a demineralization bypass 548 that comprises a first branch line 550 and a second branch line 552. An inlet 554 of a demineralization apparatus 556 is fluidically connected by first branch line 550, downstream from first water pump 528, to a first branching point 558 of discharge line 530; and an outlet 560 of demineralization apparatus 556 is fluidically connected by second branch line 552, downstream from first branching point 558, to a second branching point 562 of discharge line 530.

When first water pump 528 conveys utility water out of internal volume 540 of water tank 522 to discharge apparatus 532, the water flow splits at first branching point 558 into a part that remains in discharge line 530 and a part that is carried through demineralization bypass 548. The part that is carried through demineralization bypass 548 flows through demineralization apparatus 556 and becomes demineralized.

The demineralization apparatus, the flow resistance of demineralization bypass 548 (which also, in the exemplifying embodiment, encompasses demineralization apparatus 556), and the flow resistance of discharge line 530 between the first and the second branching point of discharge line 530 are each selected so that the water mixture, of the water flowing through discharge line 530 and the water flowing in demineralization bypass 548 (assuming a minimum value of the degree of demineralization of the utility water), which results at second branching point 562 exhibits a degree of demineralization which is at least sufficiently high that that water mixture is a demineralized water.

Demineralization apparatus 556 can be embodied as a cartridge system.

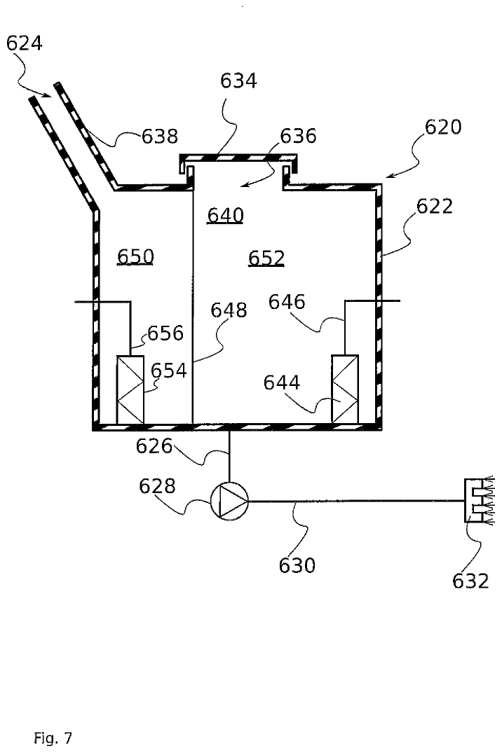

FIG. 7 shows a seventh embodiment of water delivery system 620 for delivering demineralized water to a combustion engine, only the differences from the first embodiment being discussed in the description. In the seventh embodiment, elements and components that correspond to those of the first embodiment have associated with them reference characters that are incremented by 600 with respect to the reference characters of the corresponding components and elements of the first embodiment. For those components, reference is made explicitly to the statements regarding the first embodiment, which are also to be applied to the seventh embodiment.

Water delivery system 620 comprises a demineralization apparatus 648 that is embodied with a reverse osmosis membrane that subdivides, preferably completely separates, internal volume 640 of water tank 622 into a utility-water sub-volume 650 and a clean-water sub-volume 652. The reverse osmosis membrane is preferably injection-applied onto an inner surface of water tank 622. A further water quality sensor 654, which is embodied as a water conductivity sensor and furnishes via a signal line 656 a signal that carries information regarding a degree of demineralization of the utility water in utility-water sub-volume 650, can also be arranged in utility-water sub-volume 650. Water quality sensor 644 furnishes, via signal line 646, a signal that carries information regarding the degree of demineralization of the water in clean-water sub-volume 652 demineralized by demineralization apparatus 648. Aspiration line 626 fluidically connects first water pump 628 to clean-water sub-volume 652.

When utility water or tap water is introduced through filling opening 624 into utility-water sub-volume 650, a pressure produced by the gravitational force of the water pushes water molecules through the reverse osmosis membrane of demineralization apparatus 648 so that demineralized water accumulates in clean-water sub-volume 652. Alternatively, the utility water in utility-water sub-volume 650 can be impinged upon by a pressure by way of a pressure impingement apparatus (not shown), for instance by way of a fluid pressure source such as compressed air delivery, which pressure then pushes water molecules through the reverse osmosis membrane of demineralization apparatus 648.

If further water quality sensor 654 ascertains a lower limit value for a degree of demineralization of the utility water in utility-water sub-volume 650, water delivery system 620 can then output a signal that utility-water sub-volume 650 must be emptied or that the utility water in utility-water sub-volume 650 must be diluted, since otherwise the osmotic pressure across the reverse osmosis membrane can no longer be overcome, and water molecules cannot be pushed into clean-water sub-volume 652.

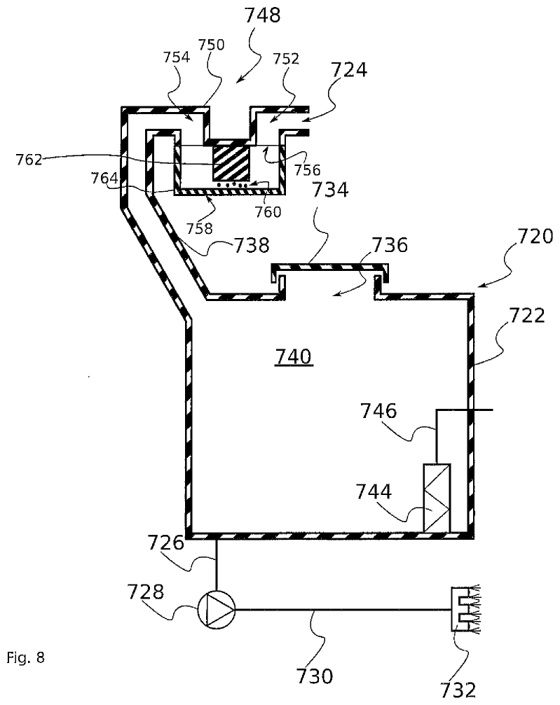

FIG. 8 shows an eighth embodiment of water delivery system 720 for delivering demineralized water to a combustion engine, only the differences from the first embodiment being discussed in the description. In the eighth embodiment, elements and components that correspond to those of the first embodiment have associated with them reference characters that are incremented by 700 with respect to the reference characters of the corresponding components and elements of the first embodiment. For those components, reference is made explicitly to the statements regarding the first embodiment, which are also to be applied to the eighth embodiment.

Water delivery system 720 encompasses a demineralization apparatus 748 that is embodied as a cartridge system. Demineralization apparatus 748 encompasses a filler-neck-mounted housing part 750 that is embodied, in particular, integrally with filler neck 738. Housing part 750 encompasses an inlet 752 of demineralization apparatus 748 and an outlet 754 of demineralization apparatus 748. Housing part 750 further comprises a cartridge opening 756 into which a cartridge 758 is inserted with the aid of fastening means, such as threads, clips, or screws. Because inlet 752 and outlet 754 are arranged on a side of cartridge opening 756 which is located oppositely from cartridge 758, a siphon-shaped water flow is formed in the cartridge system. A demineralizing active substance, which is embodied in the form of a demineralizing tablet 762 and generates a precipitate 760 in the context of a demineralizing process, is provided in cartridge 758. Cartridge 758 can be embodied in the form of a shell 764.

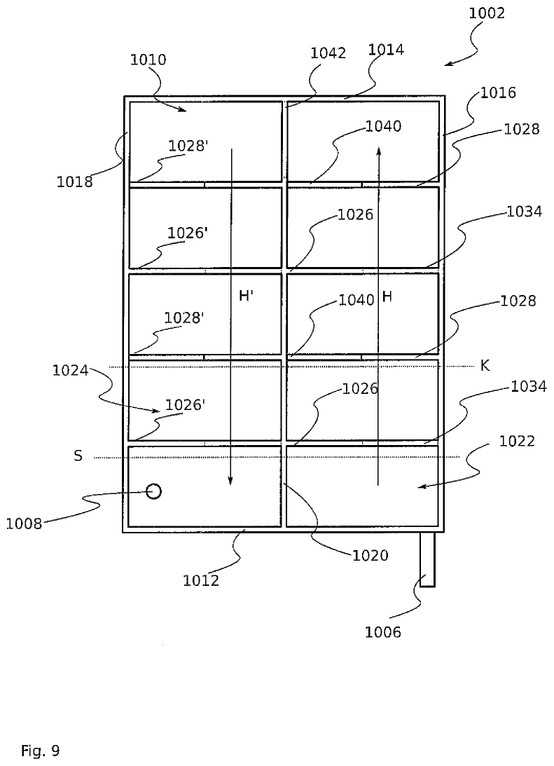

FIGS. 9 and 14 show a first embodiment of a demineralization apparatus 1000. Demineralization apparatus 1000 encompasses a housing 1002 and a housing cover 1004. An inlet 1006 and an outlet 1008 of demineralization apparatus 1000 are provided on the housing. Housing cover 1004 is preferably fastened on housing 1002 intentionally detachably and reattachably, by way of fastening means (not shown) such as screws or clips. Housing 1002 can be manufacturing using an injection-molding process.

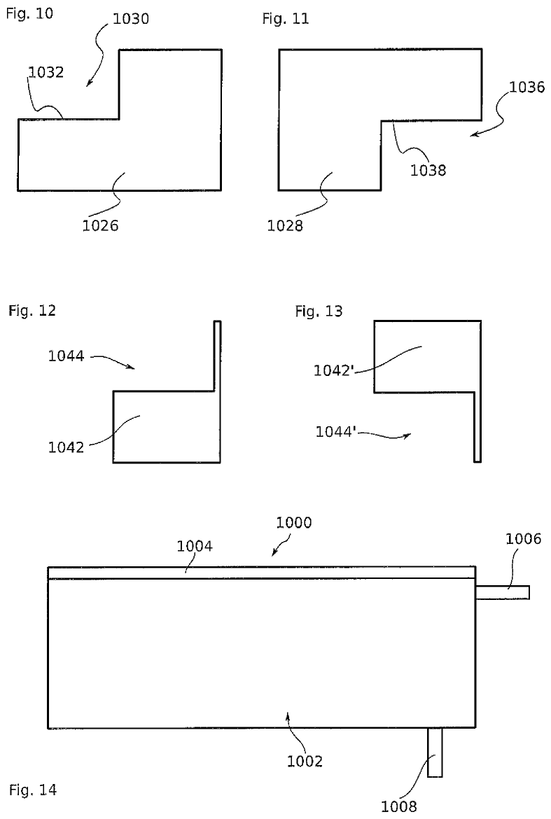

Housing 1002 is preferably in the shape of a cuboid whose bottom surface 1010 extends parallel to the drawing plane of FIG. 9, which is a view onto housing 1002 from above. The housing has two end walls 1012, 1014, two side walls 1016, 1018, and a center wall 1020. A first fluid flow channel 1022 is embodied between side walls 1016 and center wall 1020, and a second fluid flow channel 1024 is embodied between second side wall 1018 and center wall 1020. Baffle plates 1026 and further baffle plates 1028, which respectively connect side wall 1016 to center wall 1020, are arranged in first fluid flow channel 1022. Each individual one of baffle plates 1026 and further baffle plates 1028 can be embodied integrally with side wall 1016 and/or with center wall 1020 and/or with a housing floor, for example embodied using an injection-molding process. FIGS. 10 and 11 are views of one of baffle plates 1026 and one of further baffle plates 1028 in a principal fluid flow direction H that extends in a straight line and extends parallel to a principal direction of extent of first fluid flow channel 1022 and preferably coincides therewith; when the demineralization apparatus is in an assembled state, the upper edges of baffle plate 1026 and of further baffle plate 1028 which are depicted in the Figure face toward housing cover 1004.

A further baffle plate 1028 preferably directly follows a baffle plate 1026. Likewise, a baffle plate 1026 preferably follows a further baffle plate 1028. In first fluid flow channel 1022, baffle plates 1026 and further baffle plates 1028 are preferably arranged alternately following one another in principal fluid flow direction H.

Baffle plate 1026 comprises a cutout 1030 whose inner edge 1032, constituting an edge portion, defines, together with bottom surface 1010 and side wall 1016, an edge of a passthrough opening 1034 in a first fluid flow channel 1022, the opening cross section of which opening is smaller than an opening cross section of the fluid flow channel along a first section plane S that extends perpendicularly to the drawing plane of FIG. 9 and is located upstream from baffle plate 1026. Section plane S is selected by way of example, and corresponding section planes can be selected analogously for all baffle plates 1026.

Further baffle plate 1028 comprises a cutout 1036 whose inner edge 1038, constituting an edge portion, defines, together with an inner surface of housing cover 1004 and with center wall 1020, an edge of a passthrough opening 1040 in fluid flow channel 1022, the opening cross section of which opening is smaller than an opening cross section of the fluid flow channel along a second section plane K that extends perpendicularly to the drawing plane of FIG. 9 and is located upstream from further baffle plate 1028. Section plane K is selected by way of example, and corresponding section planes can be selected analogously for all further baffle plates 1028. Passthrough openings 1040 are depicted in FIG. 9 for the sake of clarity even though FIG. 9 does not show housing cover 1004, and those reference characters are thus to be understood to designate a symbolic opening.

If passthrough opening 1034 is projected in direction H (or antiparallel thereto) onto passthrough opening 1040, that projection of passthrough opening 1034 does not overlap with passthrough opening 1040.

Embodied in demineralization apparatus 1000 in fluid flow channel 1022, between a baffle plate 1026 and an adjacent further baffle plate 1028, or a baffle plate 1026 and the adjacent end wall 1012, or a further baffle plate 1028 and the adjacent end wall 1014, are respective chambers in which a demineralizing active substance (not shown) is received, e.g. in which an ion exchanger is received. A length of the flow path of the water in demineralization apparatus 1000 through the demineralizing active substance can be adapted to utilization requirements as a result of the arrangement of passthrough openings 1034 and 1040.

Second fluid flow channel 1024, having baffle plates 1026′ and further baffle plates 1028′ arranged therein, is embodied mirror-symmetrically, with reference to the center plane of center wall 1020, with respect to first fluid flow channel 1022. Principal fluid flow direction H′ of fluid flow channel 1024, which extends along a straight line and extends parallel to a principal direction of extent of first fluid flow channel 1024, extends antiparallel to principal fluid flow direction H.

Fluid flow channel 1022 is fluidically connected to fluid flow channel 1024 thanks to the provision of a baffle plate 1042 as part of center wall 1020, baffle plate 1042 being directly adjacent to end wall 1014. Baffle plate 1042 comprises a recess 1044 that, together with center wall 1020 and bottom surface 1010, defines a passthrough opening between fluid flow channel 1022 and fluid flow channel 1024. Alternatively, a baffle plate 1042′ that has an aperture 1044′ can be used. The upper edges of baffle plates 1042 and 1042′ shown in FIGS. 12 and 13 face toward housing cover 1044 when the demineralization apparatus is in an assembled state.

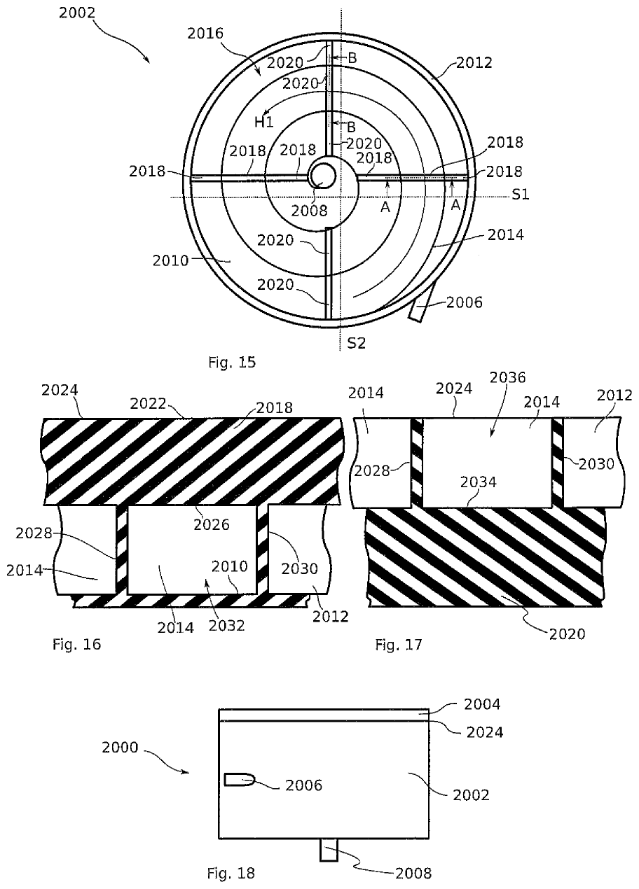

FIGS. 15 and 18 show a second embodiment of a demineralization apparatus 2000. Demineralization apparatus 2000 encompasses a housing 2002 and a housing cover 2004. An inlet 2006 and an outlet 2008 of demineralization apparatus 2000 are provided on the housing. Housing cover 2004 is preferably fastened, via fastening means (not shown) such as screws or clips, intentionally detachably and reattachably on housing 2002.

Housing 2002 is preferably in the shape of a cylinder whose bottom surface 2010 extends parallel to the drawing plane of FIG. 15, which is a view from above onto housing 2002. Housing 2002 has an enveloping wall 2012. In housing 2002, a spiral-shaped wall 2014 is fixedly connected to bottom surface 2010 which, together with enveloping wall 2012 and/or together with adjacent turns of that spiral-shaped wall 2014, constitutes a fluid flow channel 2016 that extends between inlet 2006 and outlet 2008 in a principal fluid flow direction H1 that extends parallel to a principal direction of extent of fluid flow channel 2016 and preferably coincides therewith. Principal fluid flow direction H1 follows a flat spiral.

Baffle plates 2018 and further baffle plates 2020 are arranged, preferably alternately following one another in principal fluid flow direction H1, in fluid flow channel 2016. A further baffle plate 2020 preferably directly follows a baffle plate 2018. A baffle plate 2018 likewise preferably follows a further baffle plate 2020.

Each individual one of further baffle plates 2020 and/or baffle plates 2018 is preferably embodied in one piece with spiral-shaped wall 2014 and/or with housing 2002, for example by injection-molding. Housing 2002 can be embodied entirely by injection molding.

Upper edge 2022 of baffle plate 2018 is preferably embodied flush with an upper edge 2024 of housing 2002. A lower edge 2026 of baffle plate 2018 is preferably embodied with a spacing from bottom surface 2010. Lower edge 2026 constitutes an edge portion and defines, together with side walls 2028, 2030 of fluid flow channel 2016 and with bottom surface 2010, an edge of a passthrough opening 2032 in fluid flow channel 2016, the opening cross section of which opening is smaller than an opening cross section of fluid flow channel 2016 along a first section plane S1 which extends perpendicularly to the drawing plane of FIG. 15 and is located upstream from baffle plate 2018. Section plane S1 is selected by way of example, and corresponding section planes can be selected analogously for all baffle plates 2018.

Each of side walls 2028, 2030 can be part of spiral-shaped wall 2014 or of enveloping wall 2012.

Further baffle plate 2020 is embodied preferably flush, in particular continuously and/or integrally, with bottom surface 2010 and/or with spiral-shaped wall 2014, an upper edge 2034 of further baffle plate 2020 being spaced away from upper edge 2024 of housing 2002. Upper edge 2034 constitutes an edge portion and defines, together with side walls 2028, 2030 of fluid flow channel 2016 and with an inner surface of housing cover 2004, an edge of a passthrough opening 2036 in fluid flow channel 2016, the opening cross section of which opening is smaller than an opening cross section of the fluid flow channel along a section plane S2 which extends perpendicularly to the drawing plane of FIG. 15 and is located upstream from further baffle plate 2020. Section plane S2 is selected by way of example, and corresponding section planes can be selected analogously for all further baffle plates 2020. Passthrough opening 2036 is depicted in FIG. 17 for the sake of clarity even though that Figure does not show a housing cover 1004, and that reference character is to be understood to designate a symbolic opening.

If passthrough opening 2036 is projected in direction H1 (or antiparallel thereto) onto passthrough opening 2032, that projection of passthrough opening 2036 does not overlap with passthrough opening 2032.

Embodied in demineralization apparatus 2000 between a baffle plate 2018 and an adjacent further baffle plate 2020 are respective chambers in which a demineralizing active substance (not shown) is respectively received, e.g. in which an ion exchanger is received. A length of the flow path of the water in demineralization apparatus 2000 can be adapted to utilization requirements as a result of the arrangement of passthrough openings 2032 and 2036.

Only a portion of the respective sections is depicted in FIGS. 16 and 17.

In demineralization apparatuses 1000 and 2000, utility water can be introduced into the respective inlet and the utility water becomes demineralized, on the way to the respective outlet, by the demineralizing active substance arranged in the demineralization apparatus.

For easier readability, principal directions of extent of fluid flow channels are regarded as equivalent to the associated principal fluid flow directions, and the same reference characters are used.

While considerable emphasis has been placed on the preferred embodiments of the invention illustrated and described herein, it will be appreciated that other embodiments, and equivalences thereof, can be made and that many changes can be made in the preferred embodiments without departing from the principles of the invention. Furthermore, the embodiments described above can be combined to form yet other embodiments of the invention of this application. Accordingly, it is to be distinctly understood that the foregoing descriptive matter is to be interpreted merely as illustrative of the invention and not as a limitation.

1-15. (canceled)

16. A water delivery system for delivering demineralized water to a consuming unit in a motor vehicle, in particular to a combustion engine, encompassing:
a water tank having a filling opening;
a first aspiration line;
a first water pump;
a discharge line;
a discharge apparatus;
a demineralization apparatus for demineralizing water,
the first water pump being fluidically connected via the first aspiration line to an internal volume of the water tank;
the discharge apparatus being fluidically connected via the discharge line to the first water pump,
wherein
a) the water delivery system encompasses a demineralization circuit that comprises a second aspiration line, a second water pump, a pump line, and a return line, the second water pump being fluidically connected via the second aspiration line to an internal volume of the water tank; an inlet of the demineralization apparatus being fluidically connected via the pump line to the second water pump; and an outlet of the demineralization apparatus being fluidically connected via the return line to the internal volume of the water tank; or
b) the water delivery system encompasses a demineralization arm that comprises a three-way valve, a pump line, and a return line, a first discharge line sub-portion of the discharge line fluidically connecting the three-way valve to the first water pump; a second discharge line sub-portion of the discharge line fluidically connecting the three-way valve to the discharge apparatus; the pump line fluidically connecting an inlet of the demineralization apparatus to the three-way valve; and an outlet of the demineralization apparatus being fluidically connected via the return line to the internal volume of the water tank; or
c) the water delivery system encompasses a filler neck that fluidically connects the filling opening to the internal volume of the water tank; and the demineralization apparatus is arranged in the filler neck; or
d) the water delivery system encompasses, downstream from the first water pump, a demineralization bypass that comprises a first branch line and a second branch line, an inlet of the demineralization apparatus being fluidically connected by the first branch line to a first branching point of the discharge line downstream from the first water pump; and an outlet of the demineralization apparatus being fluidically connected by the second branch line to a second branching point of the discharge line downstream from the first branching point; or
e) the demineralization apparatus divides the internal volume of the water tank into two separate sub-volumes; or
f) the water delivery system encompasses, upstream from the first water pump, a demineralization arm that comprises a three-way valve, a pump line, a direct aspiration line, an intermediate line, and a demineralization aspiration line, the pump line fluidically connecting the three-way valve to the first water pump; the direct aspiration line fluidically connecting the three-way valve directly to the internal volume of the water tank; the intermediate line fluidically connecting the three-way valve to an outlet of the demineralization apparatus; and the demineralization aspiration line fluidically connecting an inlet of the demineralization apparatus directly to the internal volume of the water tank; the first aspiration line being embodied as the direct aspiration line.

17. The water delivery system according to claim 16, wherein the consuming unit is a combustion engine, a fuel cell or a battery cooling circuit.

18. The water delivery system according to claim 16, wherein the demineralization apparatus is embodied with a replaceable cartridge.

19. The water delivery system according to claim 16, wherein the demineralization apparatus divides the internal volume of the water tank into two separate sub-volumes; and the demineralization apparatus is embodied with a reverse osmosis membrane.

20. The water delivery system according to claim 16, wherein the water delivery system encompasses a water quality sensor fluidically connected to the internal volume of the water tank.

21. The water delivery system according to claim 16, wherein the demineralization apparatus encompasses an ion exchanger as a demineralizing active substance.

22. The water delivery system according to claim 16, wherein the demineralization apparatus encompasses at least one demineralizing active substance that generates a precipitate in the context of a water demineralization process.

23. The water delivery system according to claim 16, further comprising a discharge arm downstream from the first water pump, the discharge arm comprising a further three-way valve, a first discharge line sub-portion of the discharge line, a second discharge line sub-portion of the discharge line, and a return line; the first discharge line sub-portion fluidically connecting the first water pump to a first port of the further three-way valve; the second discharge line sub-portion fluidically connecting a second port of the further three-way valve to the discharge apparatus; and the return line fluidically connecting a third port of the further three-way valve to the internal volume of the water tank.

24. The water delivery system according to claim 16, wherein the demineralization apparatus encompassing:
an inlet;
an outlet;
a fluid flow channel extending between the inlet and the outlet;
a baffle plate arranged transversely to a principal direction of extent of the fluid flow channel,
wherein the baffle plate is shaped in such a way that the baffle plate constitutes an edge portion of a passthrough opening in the fluid flow channel, the opening cross section of which opening is smaller than an opening cross section of the fluid flow channel upstream from the baffle plate.

25. The water delivery system according to claim 24, wherein the demineralization apparatus further encompassing a further baffle plate arranged, directly downstream from the baffle plate, transversely to the principal direction of extent of the fluid flow channel,
wherein the further baffle plate is shaped in such a way that the further baffle plate constitutes an edge portion of a further passthrough opening in the fluid flow channel, the opening cross section of which opening is smaller than an opening cross section of the fluid flow channel upstream from the further baffle plate; and a projection of the further passthrough opening along the principal direction of extent of the fluid flow channel does not completely overlap with the passthrough opening.

26. The water delivery system according to claim 24, wherein the principal direction of extent of the fluid flow channel, at least in portions, follows a flat spiral; and/or, at least in portions, follows a straight line; and/or, at least in portions, follows the course of a helix or coil.

27. A demineralization apparatus encompassing:
an inlet;
an outlet;
a fluid flow channel extending between the inlet and the outlet;
a baffle plate arranged transversely to a principal direction of extent of the fluid flow channel,
wherein the baffle plate is shaped in such a way that the baffle plate constitutes an edge portion of a passthrough opening in the fluid flow channel, the opening cross section of which opening is smaller than an opening cross section of the fluid flow channel upstream from the baffle plate.

28. The demineralization apparatus according to claim 27, further encompassing a further baffle plate arranged, directly downstream from the baffle plate, transversely to the principal direction of extent of the fluid flow channel,
wherein the further baffle plate is shaped in such a way that the further baffle plate constitutes an edge portion of a further passthrough opening in the fluid flow channel, the opening cross section of which opening is smaller than an opening cross section of the fluid flow channel upstream from the further baffle plate; and a projection of the further passthrough opening along the principal direction of extent of the fluid flow channel does not completely overlap with the passthrough opening.

29. The demineralization apparatus according to claim 27, wherein the principal direction of extent of the fluid flow channel, at least in portions, follows a flat spiral; and/or, at least in portions, follows a straight line; and/or, at least in portions, follows the course of a helix or coil.

30. A vehicle having a consuming unit, in particular a combustion engine, and having a water delivery system according to claim 16, wherein the water delivery system delivers the demineralized water to the consuming unit.

31. A method for operating a water delivery system having the features of claim 16, wherein the demineralization apparatus is embodied with a replaceable cartridge and wherein the water delivery system further comprising a discharge arm downstream from the first water pump, the discharge arm comprising a further three-way valve, a first discharge line sub-portion of the discharge line, a second discharge line sub-portion of the discharge line, and a return line; the first discharge line sub-portion fluidically connecting the first water pump to a first port of the further three-way valve; the second discharge line sub-portion fluidically connecting a second port of the further three-way valve to the discharge apparatus; and the return line fluidically connecting a third port of the further three-way valve to the internal volume of the water tank; the method encompassing the following steps:
detecting, by way of a water quality sensor, a degree of demineralization of water in the internal volume of the water tank and carrying out the following steps when the degree of demineralization is below a predetermined or determinable lower threshold value:
either, in accordance with an operating mode A:
switching the three-way valve into a demineralization aspiration state and switching a further three-way valve into a circulation state in which the first port and the third port of the further three-way valve are opened for the passage of fluid, and the second port of the further three-way valve is closed;
conveying water or utility water out of the water tank by the first water pump through the demineralization apparatus;
demineralizing the water component conveyed through the demineralization apparatus;
returning that demineralized water component into the internal volume of the water tank; and
terminating that demineralization process when the water quality sensor detects a degree of demineralization in the internal volume of the water tank which is above the predetermined or predeterminable lower threshold value or above a predetermined or predeterminable stop threshold value that is above the lower threshold value;
or, in accordance with an operating mode B:
switching the three-way valve into a demineralization aspiration state and switching a further three-way valve into a discharge state in which the first port and the second port of the further three-way valve are opened for the passage of fluid, and the third port of the further three-way valve is closed; and
conveying water or utility water out of the water tank by the first water pump through the demineralization apparatus to the discharge apparatus.

32. The method according to claim 31, wherein the consuming unit is a combustion engine; and the operating mode A is selected when the combustion engine is shut off, and the operating mode B is selected when the combustion engine is operating.
